(19) United States
(12) Patent Application Publication
(10) Pub. No.: US 2015/0341492 A1
(43) Pub. Date: Nov. 26, 2015

(54) COLLECTION COMPLIANCE SYSTEM

(71) Applicant: Richard P. BOUDRIEAU, Duxbury, MA (US)

(72) Inventor: Richard P. BOUDRIEAU, Duxbury, MA (US)

(73) Assignee: GRYPHON NETWORKS CORP., Norwood, MA (US)

(21) Appl. No.: 14/283,551

(22) Filed: May 21, 2014

(51) Int. Cl. H04M 3/436; H04M 3/51

(52) U.S. Cl. CPC H04M 3/436; H04M 3/5175; H04M 3/5166

(57) ABSTRACT

Techniques for selectively prohibiting or allowing a debt collection call are disclosed. In an example, a method processing a debt collection call may include receiving a collections compliance request with at least a To number and a From number, identifying a client based on the From number, determining if the To number is included in a client no-contact list, determining if a call frequency count value is appropriate, such that the call frequency count value is based on the To number, determining if a curfew value is being exceeded based on a current time and the To number, allowing the debt collection call to proceed if the To number is not included in the client no-contact list, the call frequency count value is appropriate, and the curfew value is not being exceeded, and prohibiting the debt collection call if the To number is included in the client no-contact list, the call frequency count value is not appropriate, or the curfew value is being exceeded.

### BACKGROUND

The U.S. federal Fair Debt Collection Practices Act (FDCPA) and associated regulations provide specific legal requirements governing collection practices for delinquent debts. States maintain their own debt collection laws which can vary from the FDCPA requirements.

Many consumer protections prescribed by these laws relate to telephone, mail and other communications with debtors and third parties, such as who, when, how often, for what purpose contacts may be made, and what legal disclosures must be made during such communications. For example, a debt collector may not communicate with a consumer in connection with the collection of any debt at inconvenient times, such as before 8:00 am or after 9:00 pm, at work if told that the debtor is not allowed to get calls there, or if instructed in writing by the debtor. If a debtor informs a debt collector they are represented by an attorney, the debtor must refrain from contacting the debtor and limit contact to the attorney. If a debtor does not have an attorney collectors are generally permitted to contact other people, on one occasion, to find out a debtors address, home phone number or where they work. Debt collectors also must send a “validation notice” to a debtor within five days after first contacting the debtor. If a debtor sends a letter to a collector within thirty days of the validation notice stating they do not owe any or all of the money or asking for a verification of a debt, the debtor must stop contacting the consumer until the debtor sends verification of the debt. Many collection agents also maintain their own business requirements that may exceed those required by legal requirements.

Violations of debt collection laws may be enforced by state and federal regulators including state Attorneys General, the Federal Trade Commission and the Consumer Financial Protection Bureau. Consumers may also sue a collector in a state or federal court for unlawful collection practices and recover actual damages or up to $1,000 in statutory damages, as well as attorneys fees and court costs. Class actions are also allowed to recover money for damages of up to $500,000, or one percent of the collector's net worth, whichever amount is lower. Similar laws and enforcement regimes also exist in other countries. Thus, there is a need to create a system to assist debt collection agents in complying with debt collection legal and business requirements and to facilitate a process for compliance with future collection requirements.

### SUMMARY

An example of a method for selectively prohibiting or allowing a debt collection call according to the disclosure includes receiving a collections compliance request with at least a To number and a From number, identifying a client based on the From number, determining if the To number is included in a client no-contact list, determining if a call frequency count value is appropriate, such that the call frequency count value is based on the To number, determining if a curfew value is being exceeded based on a current time and the To number, allowing the debt collection call to proceed if the To number is not included in the client no-contact list, the call frequency count value is appropriate, and the curfew value is not being exceeded, and prohibiting the debt collection call if the To number is included in the client no-contact list, the call frequency count value is not appropriate, or the curfew value is being exceeded.

Implementations of such a system may include one or more of the following features. Determining if the To number is included in a sub-account no-contact list, such that a sub-account is associated with the client. Determining if the To number is included in a campaign no-contact list, such that a campaign is associated with the client. The call frequency count value may be based on a sub-account. The call frequency count value may be based on a campaign. Determining if the To number meets an override requirement, allowing the debt collection call to proceed if the override requirement is met, and prohibiting the debt collection call if the override requirement is not met, and if any one of the following is true: the To number is included in the client no-contact list, the call frequency count value is not appropriate, or the curfew value is being exceeded. A call compliance audit log may be updated to indicate whether the debt collection call was allowed or prohibited. Sending a pre-call notification message based on the From number. The collections compliance request may be received by an Interactive Voice Response application. The collections compliance request may be received from a Customer Relationship Management system (CRM). A compliance settings page may be presented to a user and utilized for receiving one or more frequency limits, receiving one or more curfew periods, receiving one or more client no-contact numbers, and storing the compliance settings page. Prohibiting the debt collection call may include prohibiting the debt collection call if the To number is associated with a wireless device. Prohibiting the debt collection call may include prohibiting the debt collection call if the To number is associated with a particular area code. The To number and the From number may be computer readable information.

An example of a system for assisting an agent in complying with debt collection laws and business requirements according to the disclosure includes a memory, at least one processor operably coupled to the memory and configured to receive a collections compliance request including a To number and a From number, identify a client based on the From number, determine if the To number is blocked, determine is an override is available, determine if a client opt-in requirement is satisfied, allowing a call to the To number if the To number is not blocked, or the override is available, or the client opt-in requirement is satisfied, and blocking the call to the To number is the To number is blocked, and the override is not available, and the client opt-in requirement is not satisfied.

Implementations of such a system may include one or more of the following features. The processor may determine the To number is blocked if the processor determines that a current call frequency count value for the To number is exceeded. The processor may determine the To number is blocked if the processor determines that a call curfew value is being violated. The processor may be configured to provide a pre-call notification message to the agent. The processor may be configured to provide a do not contact message to the agent. The collections compliance request may be received from a Customer Relationship Management system (CRM).

Items and/or techniques described herein may provide one or more of the following capabilities, as well as other capabilities not mentioned. A database engine may maintain collection rules. Additional rules may be added based on legal requirements, corporate procedures, or other factors. Outgoing collection calls may be validated using the rules in the database engine. The rules database can be updated based on a collections call. Consistent application of the rules may be applied across multiple locations and collection agents. The Collection Compliance System may be a call through service or may be integrated with a Private Branch Exchange (PBX). Audit logs may be maintained and distributed to help ensure compliance with collections rules. Other capabilities may be provided and not every implementation according to the disclosure must provide any, let alone all, of the capabilities discussed. Consumers may be freed from the nuisance of illegal and/or unprofessional collection efforts. Further, it may be possible for an effect noted above to be achieved by means other than that noted, and a noted item/technique may not necessarily yield the noted effect.

### BRIEF DESCRIPTION OF THE DRAWINGS

FIG. 1 is an example control system interconnected with a communications network.

FIG. 2A is an exemplary table organization of a data structure of a database in which the collection compliance rules and variables are stored.

FIG. 2B is an exemplary table organization of a data structure of database in for use with exemption records.

FIG. 3 is an exemplary flow chart for storing collection call compliance settings.

FIG. 4 is an exemplary flow chart for processing a potential communication from an origin to a destination and automatically updating call frequency, no-contact, opt-in duration, or override databases.

FIG. 5 is a block diagram of an example of a computer system.

### DETAILED DESCRIPTION

Techniques are discussed herein for assisting collection agents with conforming to established Federal and State regulations on collection calls to consumers. For example, compliance rules and variables are stored as database records. A centralized database is accessed by clients via a telecommunication network. Collection calls may be evaluated at the time of the call. Compliance rules and variables are used in a decision to prohibit or allow a call to a consumer. Client specific no contact lists, call frequency values, and call curfew values may be verified when a collection call is made. Clients may implement compliance rules and variables for multiple offices and multiple agents. Compliance rules and variables may be indexed by clients, states, area codes and consumers. A no contact message is provided to a client when a consumer call is prohibited. Audit logs are generated to review allowed and prohibited calls. These examples, however, are not exhaustive.

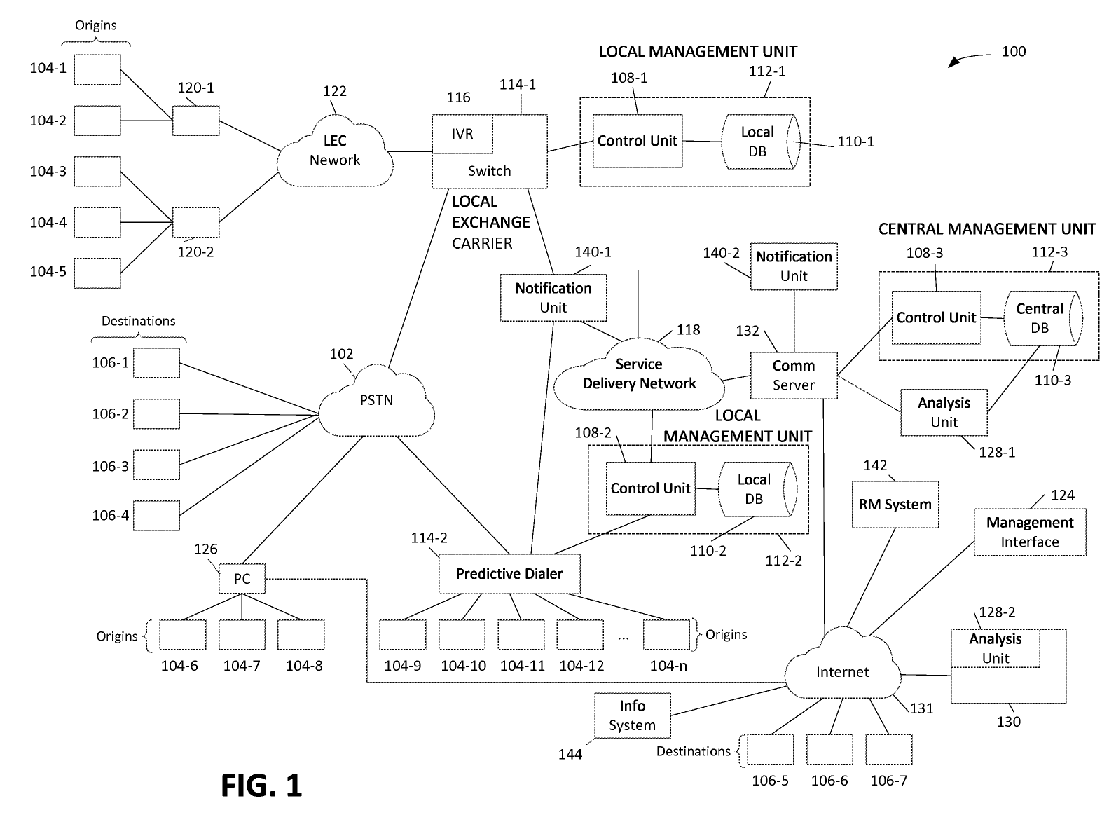

Referring to FIG. 1, an example of a control system 100 interconnected with telecommunications network 102, i.e., the Public Switched Telecommunications Network (PSTN), is shown. The network includes multiple originating stations 104-1 to 104-n (collectively referred to as origin 104), multiple destination stations 106-1 to 106-7 (collectively referred to as destination 106), and other computerized devices between the origin 104 and destination 106. To selectively prohibit or allow a communications connection between an origin 104 and a destination 106, preferably in real-time or near real-time, one or more control units 108-1, 108-2, 108-3 interfaces with one or more databases 110-1, 110-2, 110-3, collectively referred to herein as management units 112-1, 112-2, 112-3 respectively. As used herein, a control unit 108, a database 110, and a management unit 112, generally correspond to one or more of the respective control units, databases, and management units on FIG. 1. The origin 104 and destination 106 are typically telephones, but may be other types of communications devices such as cellular telephones, personal digital assistances, pagers, computers, computer client interfaces, or remote computer terminals. Origin 104 and destination 106 may each be connected directly or indirectly to PSTN 102. For example, origin 104-1 may be connected through office private branch exchange (PBX) 120-1 (or 120-2) to local exchange carrier network 122 which connects to local exchange carrier connection unit 114-1, a telecommunications switch. A destination identifier is usually a network address associated directly or indirectly with a destination communications device or a destination user. For example, the device address may be a telephone number for a device connected to the PSTN 102, an Internet Protocol (IP) address for a device connected to the Internet, or an electronic mail address for an Internet electronic mail account in an electronic mail server.

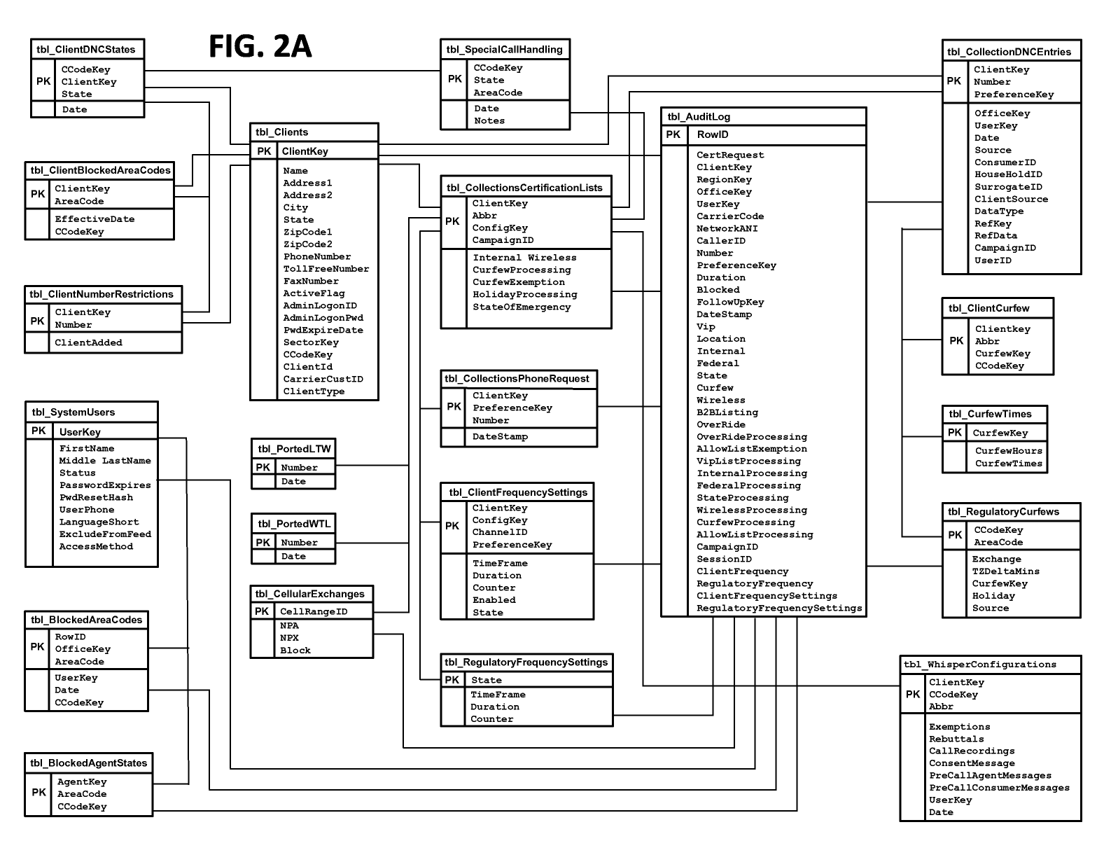

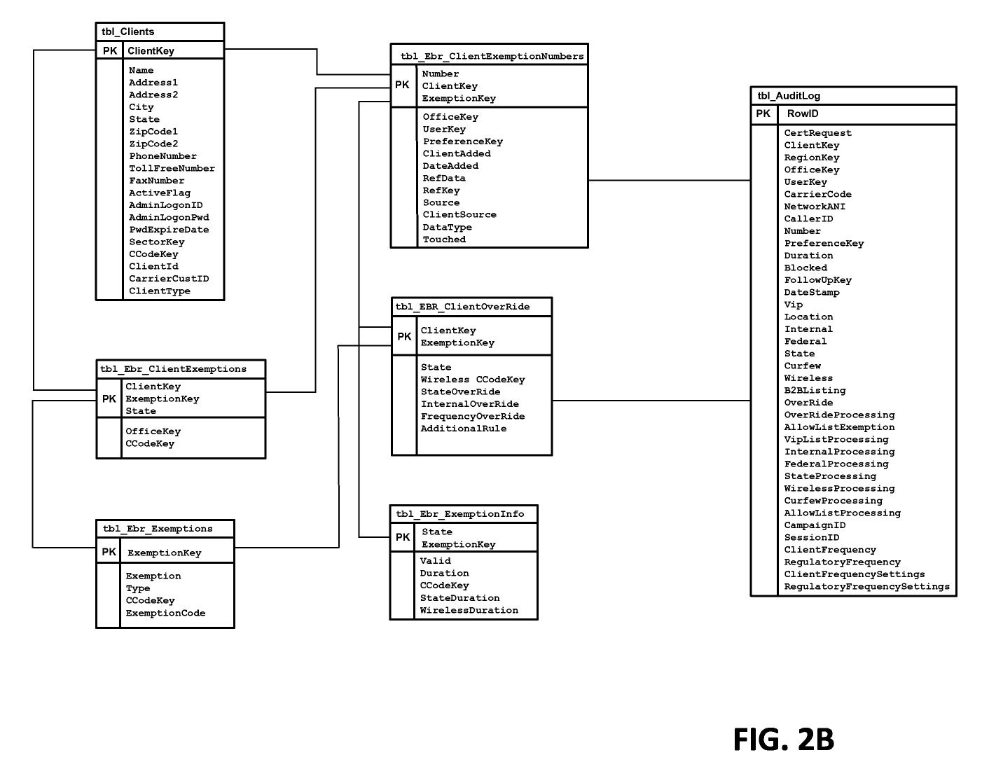

The database 110 may have one or more tables or other data structures comprising compliance rules, or the variables associated with compliance rules, as shown in FIGS. 2A and 2B. Using one or more compliance rules or other variables (e.g., Blocked Area Codes, Number Restrictions, Cellular Exchanges, Frequency settings, Curfew information) in database 110, control unit 108 determines whether a communications connection between a particular origin 104 and destination 106 is prohibited or allowed. To facilitate a more rapid response to a communications connection request, management unit 112 may be mirrored at a client's local facility or local carrier exchange. For example, local management unit 112-1, comprising local control unit 108-1 and local database 110-1, may control communications connections established by connection unit 114-1, a telecommunication switch with Interactive Voice Response application (IVR) 116. Another local management unit 112-2, comprising local control unit 108-2 and local database 110-2, may control communications connections established by connection unit 114-2, which in this example is a predictive dialer for multiple origins 104 such as 104-9.

A central management unit 112-3, comprising control unit 108-3 and database 110-3, may control communications connections. Central management unit 112-3 may interface with any connection unit 114 via service delivery network 118 or any other remote computer or interface such as computer 126, management interface 124, and computer 130 via network 131 which, in this instance, may be the Internet.

The control unit 108 may be a computer server or gateway that resides on the premises of a client, a local exchange carrier, local administration facility, central administration facility, or other remote facility. Each control unit 108 and database 110 may be periodically synchronized with other control units 108 and databases 110. Local databases 110-1 and 110-2 are typically not as large as 110-3 because the local databases may only need compliance rules and other variables specific to a local client while database 110-3 typically holds the rules and variables for all clients. While the control unit 108-1 interfaces with local collection compliance rules and variables in database 110-1, control unit 108-1 may also interface with other compliance rules and variables in other databases 110 being remotely located at another facility such as another local administration facility wherein database 110-2 may be located. Control unit 108-1 or other control units 108 may interface remotely with databases 110 located in other locations such as a local exchange carrier, central administration facility, or remote facility.

Central management unit 112-3 and local management units 112-1 and 112-2 typically communicate with each other via Service Delivery Network 118 which may be a private network, a virtual private network within the Internet, a wide area network, local area network, or the like. Service Delivery Network 118 preferably is protected from eavesdropping with adequate security mechanisms such as encryption and authentication.

While FIG. 1 illustrates local management units 112-1 and 112-2 controlling the communications connection between an origin 104 and destination 106 by interfacing with connection units 114-1 and 114-2 respectively, either control unit 108 or both the control unit 108 and database 110 may be incorporated into the functionality of any connection unit 114 such as connection units 114-1 and 114-2, effecting direct control of the communications connection by the control unit 108. From another perspective, control unit 108 itself may establish the communications connection between an origin 104 and destination 106. It may, however, be more advantageous to utilize a separate management unit 112 that interfaces with multiple connection units 114 to reduce the overall cost of implementing communications connection control throughout a communications network.

In addition to being a telecommunications switch having an IVR application or a predictive dialer, connection unit 114 may be a distributed predictive dialer system, a router, a switch, electronic mail server, or a computer server such as a personal computer. The connection unit 114 generally acts as a bridging circuit to establish a communications connection between an origin 104 and destination 106. The connection unit 114 may receive or initiate a request for a communications connection between an origin 104 and destination 106 that includes the destination identifier. For example, connection unit 114-1, typically uses IVR 116 to receive a call from an origin 104-1. In this call through model, the client user may use origin 104-1, e.g., a telephone, to dial a “1-800” number to obtain access to IVR 116. Once connected, IVR 116 will prompt the client user to enter a pin identification number between 6-10 digits. The control unit 108-1 will then validate the client user, using database 110-1 as belong to a peculiar office associated with the client. If valid, IVR 116 may prompt the client user of origin 104-1 for a 10-digit destination telephone number to subsequently place a call to a target consumer. Once the destination telephone number is received, typically using dual-tone-multi-frequency (DTMF) detection, IVR 116 sends the call destination telephone number to local management unit 112-1. Depending on the compliance rules which may be specific to a particular client or campaign, control unit 108-1 evaluates the destination telephone number based on the compliance rules and variables in the local database 110-1 and then orders connection unit 114-1 to prohibit or allow the communications connection. Further details regarding the operation of the IVR application and its interfacing capabilities with management unit 112 are provided in U.S. Pat. No. 8,526,428, the entire content which is incorporated by reference.

In a voice communications scenario, a prohibited communication with a destination identifiers may be derived from any one or of the compliance rules and variables described in FIG. 2A. For example, a communication may be prohibited for violating a curfew rule, a frequency limit, or the destination may be listed in a client specific no-contact list (e.g., a client number restriction). A client specific no-contact list may be a client-specific list that includes destination telephone numbers of consumers that the client does not want to be the destination for collection calls (e.g., place of employment, Existing Business Relationship (EBR), notification of representation of counsel). Other collection rules defined by International, Federal, State, other governmental entities, trade organizations, associations, or private entities may also be included in the compliance rules and variables. In an electronic mail scenario, a list of prohibited destination identifiers may include a client do-not-email list, Domain Name List or IP address list.

Referring to FIG. 2A an exemplary table organization of the data structure of databases 110 in which the collection compliance rules and variables are stored is shown. The tables shown are described as follows:

tbl_Clients: a table of all clients using the control system 100 including additional fields (i.e., information) about each client.

tbl_ClientDNCStates: a table of clients with a no contact status (i.e., state) and the corresponding date and time the client state was last changed.

tbl_ClientBlockedAreaCode: a table of area codes and client keys (i.e., for segregating consumer areas among clients) that enables the control unit 108 to prohibit certain agents from calling a particular area code listed in the table. An effective date variable may be included as an additional constraint.

tbl_ClientNumberRestrictions: a table of consumer contact numbers that enables the control unit 108 to prohibit a collection call from a client to a number included in the table.

tbl_SystemUsers: a table of all individual users of control system 100 including client users or agents and administrators.

tbl_BlockedAreaCodes: a table that enables control unit 108 to prohibit certain agents from calling certain area codes.

tbl_BlockedAgentStates: a table that enables control unit 108 to prohibit certain agents from calling certain states listed in the table.

tbl_PortedLTW: a table that stores phone numbers which have been ported to a cell phone device.

tbl_PortedWTL: a table that stores phone numbers which have been ported from a cell phone device.

tbl_CellularExchanges: a table that stores the standard identified range of cell phone numbers.

tbl_SpecialCallHandling: a table that stores variables for special call handling procedures such as Louisiana State of Emergency call ban tables.

tbl_CollectionsCertificationLists: a table that stores the compliance rules processing options for client or campaign. For example, the compliance rules a specific CampaignID may direct the control unit 108 to perform Curfew Processing, Holiday Processing, and State of Emergency processing, but to ignore the Internal and Wireless processing. Other combinations can be stored for other CampaignIDs and/or ClientKeys.

tbl_CollectionPhoneRequest: a table that stores a date and time that a collection call is made to a number.

tbl_ClientFrequencySettings: a table that stores variables to enable the control unit 108 determine the frequency at which a number is called. For example, the control unit 108 can count the number of calls made over a time frame.

tbl_RegulatoryFrequencySettings: a table that defines how a frequency values are defined.

tbl_Auditlog: a table that stores collection call information (i.e., variable states) to enable the control unit 108, or user, to review a specific call to verify compliance with collection regulations and client requirements. The table may be a call compliance audit log to capture when a debt collection call is allowed or prohibited.

tbl_CollectionDNCEntries: a table that stores no collection call or other marketing channel contact points records, accompanied by a date and time associated with each record

tbl_ClientCurfew: a table that stores variables to correlate a curfew time to with a client (i.e., the curfew time that a particular client will use for collection calls).

tbl_CurfewTimes: a table that defines one or more client defined collection curfew times.

tbl_RegulatoryCurfews: a table that stores variables that define curfew periods that are established by regulations within geographic areas defined by a certain area code.

tbl_WhisperConfigurations: a table that stores variables for pre-call whispers to the agent making a call.

Referring to FIG. 2B an exemplary table organization of the data structure of databases 110 in which exempted destination identifiers are stored is shown. The tables shown are described as follows:

tbl_Auditlog: a table that stores collection call information (i.e., variable states) to enable the control unit 108, or user, to review a specific call to verify compliance with collection regulations and client requirements. The table may be a call compliance audit log to capture when a debt collection call is allowed or prohibited (same as in FIG. 2A).

tbl_Clients: a table of all clients using control system 100 including information about each client (same as in FIG. 2A).

tbl_Ebr_Exemptioninfo: a table that stores the durations associated with each category exemption.

tbl_Ebr_ClientExemptions: a table that stores exemptions associated with a particular client.

tbl_Ebr_Exemptions: a table that describes the EBR exemption of EBR exemption list.

tbl_Ebr_ClientExemptionNumbers: a table that stores the list of destination identifiers in EBR exemption list including the exemption key and date of contact information. The exemption key may be used to indicate which compliance rules and variables are to be processed by the database engine. As an example, the exemption key may indicate that a call relates to Opt-In variables related to a consumer opt-in or permission that define numbers which may be contacted despite frequency, no-contact lists, or curfew restrictions for such numbers. That is, a consumer may consent to being contacted at their work telephone number after previously indicating they could not be contacted at such number. A data table may also store additional variables corresponding to effective times and dates in which the override of such restrictions may apply. For example, a client may wish to override frequency restriction for thirty days while the client and consumer are negotiating a payment plan.

tbl_EBR_ClientOverRide: a table that stores variables that define numbers which may be contacted despite frequency, no-contact lists, or curfew restrictions for such numbers. For example, a debt collector may need to contact a consumer for purposes other than debt collection, and may wish to deactivate all or a subset of debt collection table checks.

The databases 110 are configured using tables such that the compliance rules and variables may be dynamically added or removed. For example, new curfew times and frequency settings may be added to the appropriate tables within the databases 110. Clients may be related to other clients and/or organized into accounts and sub-accounts. The compliance rules and variables may be associated at the account or sub-account level (e.g., each sub-account may inherent the account compliance rules and variables from a parent account, or each sub-account may be associated with compliance rules and variables independent of a parent account). The accounts and sub accounts, and the corresponding compliance rules and variables, may also be associated with a particular campaign event. The flexibility to modify the databases 110 enables the client to validate collection calls when new collection regulations are created and the databases 110 are updated. The compliance rules and variables may preferably be implemented as tables within a database such as databases 110, the rules and variables may also be distributed throughout multiple databases or multiple tables within multiple databases. Also, the rules and variables within databases 110 may be modified by an agent via an origin 104 using IVR 116. Furthermore, the prohibited and exempted destination lists may be modified from a secondary interface such as management interface 124 or another remote connection to management units 112, typically using a WWW page interface by an agent or administrator.

In an embodiment, the control unit 108 may use other information such as a client user identifier, client identifier, consumer identifier, customer identifier, client office identifier, product identifier, geographic area, date, time, exemption type duration, origin identifier, internal client criteria, or internal consumer criteria to determine whether a destination can be contacted. That is, the control unit 108 may utilize additional information in conjunction with the compliance rules and variables of database 110 to prohibit or allow a communications connection to occur between an origin 104 and destination 106.

Referring again to FIG. 1, the functionality of control units 108 and associated database 110 may also be implemented as a software application within a remote client computer 126. Alternatively, only control unit 108 may be implemented within client computer 126 while it remotely accesses the compliance rules and variables within database 110-3, located in a central administration facility. Furthermore, computer 126 may act as a remote interface to any management unit 112. The lower cost implementation may be attractive to certain clients that may not be concerned with the possible latency in accessing database 110-3. In this scenario, client computer 126 acts as both a connection unit and control unit by allowing or prohibiting a communications connection between, for example, origin 104-6 and 106-1 based on the compliance rules and variables within an internal database 110, or within central database 110-3, or within another remote database. Computer 126, acting as a control unit, may also control the communications connection between origin 104-6 and destination 106-5 which could be a Voice-over-IP (VoIP) connection.

The control unit 108 may examine a plurality of destination identifiers (i.e., batch processing) in relation to a particular origin to determine whether to prohibit or allow a communications connection between a particular origin such as origin 104-2 and each destination of the plurality of destinations 106. The control units 108 may continuously process communications connection requests as the client agent attempts to communicate with multiple consumers.

The management units 112 may maintain audit records (e.g., tbl_AuditLog) of attempted communications connections to record whether the connection was blocked or allowed. The control units 108 may determine whether a collection call is blocked or allowed, with the result and corresponding compliance rules and variables entered as a record in the database 110. The audit log records may be stored for later analysis or other purposes. The logs may be stored as a flat, excel, or dbf file or the like.

The collection compliance system provides a method of selectively prohibiting a communications connection between an origin and destination in a communications network based on dynamic compliance regulations, or other client requirements. The method includes receiving or initiating a connection request for a communication connection between an origin 104 and destination 106 that includes the destination identifier and prohibiting or allowing the requested communications connection based on one or more compliance rules and variables in databases 110.

Referring again to FIG. 1, as an alternative approach to performing real-time or near real-time call control as described above, an analysis system may be used to selectively designate whether a communications connections between an origin and one or more destinations are prohibited. The analysis system typically includes an interface unit that receives one or more compliance rules and variables. The analysis system also includes an analysis unit 128 that designates whether the communication connection between an origin and one or more proposed destinations are prohibited or allowed based on the compliance rules and variables.

The functional capabilities of analysis units 128 may be identical to control units 108 except that analysis units 128 do not control a communication connection or connection units 114. The control units 108 may also function as analysis units. Instead of performing a real-time action, analysis units 128 may designate which destinations 106 may be connected with which origins 104. This designation of prohibited or allowed communications connections may entail analyzing one or more proposed destination identifiers (i.e., one or more To numbers) delivered to the analysis unit via an interface unit such as personal computer 130. Computer 130 may also have an application that streamlines the information sent to analysis unit 128-1 such that private information associated with a destination is not potentially exposed in transmission to analysis unit 128-1. The interface unit could also be a ftp server, an database connection, a remote terminal connection, a WWW page, or Interactive Voice Response connection residing within analysis unit 128-1 or another server such as communications server 132.

An analysis unit 128-1 may determine and send a designation list to the client computer 130. Alternatively, analysis unit 128-2 may be implemented as a software application within a remote client computer 130. Thus, analysis unit 128-2 remotely accesses the compliance rules and variables of database 110-3 within a central administration facility. Personal computer 130 may also contain a database 110 that eliminates the need for analysis unit 128-2 to remotely access other databases such as database 110-3. The analysis unit 128-1 may be configured to send one or more of the following periodic lists to client computer 130: (1) a list of destination identifiers that should not be contacted within a period; (2) a list of the destination identifiers that may be contacted within a period; and/or (3) a list of invalid destination identifiers.

A further embodiment may be a notification system for delivering messages to an origin 104 and destination 106 of a communications connection in a communications network including telecommunications network 102. The notification system may include a connection unit 114 that establishes a first connection with an origin 104 and a second connection with a destination 106 and then bridges the first and second connections to establish a communications connection between a particular origin 104 and destination 106. The notification system may also include one or more notification units 140-1, 140-2 that delivers at least one notification message to either or both an origin 104 and destination 106. For example, when an agent initiates a collections communications connection using origin 104-1 with IVR 116, notification unit 140-1 may send a notification message associated with a particular destination 106 such as destination 106-4 to origin 104-1 via IVR 116 of connection unit 114-1 in the form of a whisper message (e.g., audio message) that states “The frequency limit has been reached for this consumer,” or “The consumer is on the client no-contact list,” or “The consumer is represented by an attorney.” Notification unit 140-1 may interface with a database such as database 110-3 to determine the destination 106-4 status based on the stored compliance rules and variables. A notification message can be provided to a relationship management system 142 such as a Customer Relationship Management system (CRM), a control unit 108, or some other information system 144.

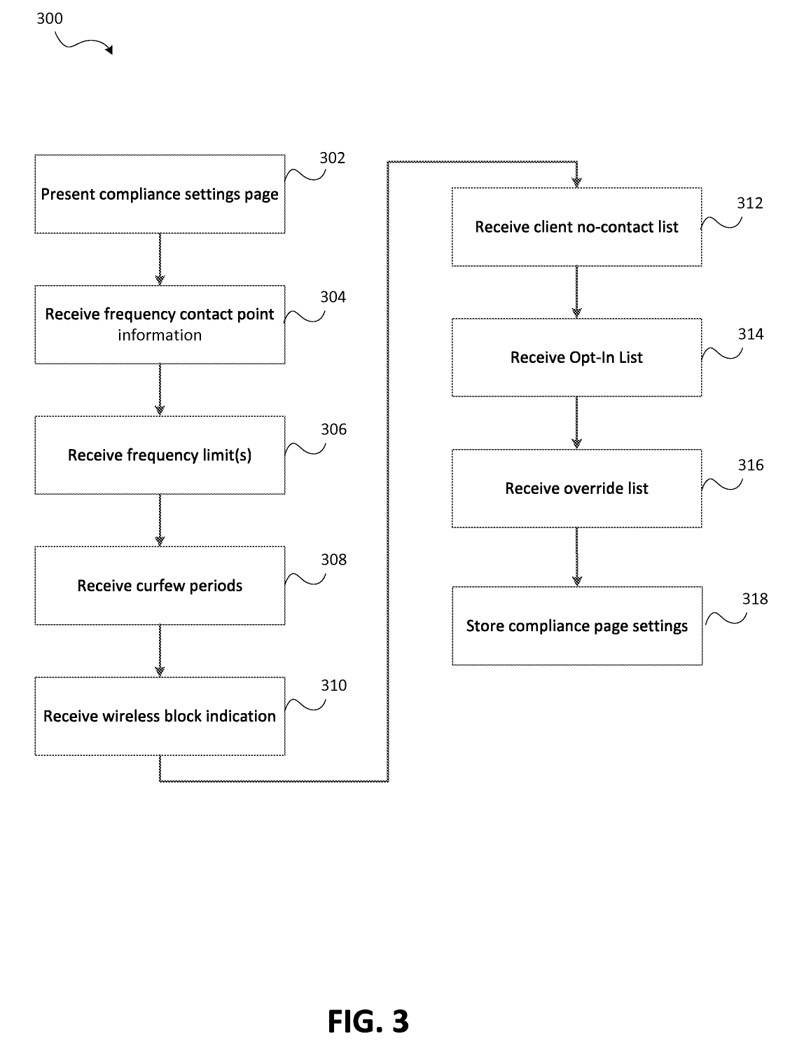

Referring to FIG. 3, with further reference to FIGS. 1, 2A and 2B, a process 300 for storing collection call compliance settings is includes the stages shown. The process 300 is, however, an example only and not limiting. The process 300 can be altered, e.g., by having stages added, removed, rearranged, combined, and/or performed concurrently. For example, a wireless block indication need not be received in the process 300, or other default values may be used and need not be entered by a user.

At stage 302, the control unit 108, management interface 124, or other client computer system 130 may be configured to present a compliance settings page to a user. In an embodiment, the compliance setting page can be Graphical User Interface (GUI) application comprising a collection of input objects such as text boxes, check boxes, radio buttons, and the like. The input objects can be associated with compliance rules and variables in the database 110. As an example, and not a limitation, the compliance setting page can be a web enabled Form (e.g., accessible via a browser), and the compliance rules and variables can be contained in a relational database (e.g., SQL, Oracle®), or other data structure (e.g., XML, flat file). Other logic layers in a software application may be used for presenting and processing compliance rules and variables may be used. While the process 300 describes presenting a GUI to a user to receive input values, other data input methods such as database connections and electronic data transfers may be used to receive and store collection compliance settings.

At stage 304, the user can provide frequency contact point information to be stored in a database 110. The contact frequency is generally measured by a unique contact point. For example, as default values, unique contact point values can be defined such that a day begins at 12:10 am, a week begins at 12:01 am Monday, and a month begins at 12:01 am on the 1^{st} day of the month. Other unique contact points may be used based on a client's business requirements, or other commercial or regulatory parameters. The compliance setting page can contain one or more GUI objects to capture the user's desired unique contact point.

At stage 306, the user can enter one or more frequency limits to be stored in the database 110. In an embodiment, the frequency limits may be associated with one or more of a state, an area code, a client, a campaign, or a consumer. In general, state collection regulations establish call frequency limits and these values may be used independent of area code, client, or consumer values. Frequency limits may be defined by day, week, and/or month. Multiple frequency limit values may be used conjunction with one another. For example, the frequency limits may be defined as “X contacts per day, not to exceed Y contacts per month,” where X and Y are stored frequency limits. In an embodiment, when both state can client frequency limits are defined, the most restrictive value may be used by the control unit 108. For example, if the state regulated contract duration is entered as 5 attempts per day, and the client contact frequency is defined as 3 attempts per day (client or campaign), the control unit 108 will block the 4^{th} attempted call. In another embodiment, the least restrictive value may be used by the control unit 108.

At stage 308, the user can enter one or more curfew periods to be stored in the database 110. The federal curfew for collection calls is before 8 am and after 9 pm local time. The federal curfew period may be the default value for the system. A user may also enter state curfew periods. The control unit 108 may be configured to use the least restrictive curfew time period if the federal and state curfew periods do not coincide with one another. In embodiment, different curfew periods may be established for different days of the week, and may also accommodate scheduled holidays. Thus, a collection call attempt made during a curfew period (e.g., after 9 pm, on a holiday, etc. . . . ) will be blocked by the control unit 108.

At stage 310, the user can set a flag (e.g., via check-box object) in the database 110 to indicate that all calls made to wireless devices a particular state will be blocked. If the wireless block indication is received, then the control unit 108 will block calls made to destination numbers that correspond to wireless phones (e.g., mobile devices).

At stage 312, the user may establish one or more client no-contact lists in the database 110. For example, a client may store one or more numbers for destinations that will be blocked from collection call attempts. These destinations may correspond to consumers who have indicated they are represented by counsel, who have indicated they are not permitted to receive calls at their place of employment and consumers with on-going business relationships with the client, and the client may not wish to make collection calls to the consumer at such number. The client no-contact list can be evaluated independently of other compliance rules and variables. In an embodiment, the client may include any numbers within an area code as a no-contact list. For example, if a client has multiple offices (e.g., client1, client2, client3) in different regions, each office (e.g., client1) may be assigned different regions (e.g., area codes) for the collection efforts. Thus, attempted calls to consumers in a non-assigned region will be blocked. A client may include sub-accounts, such that each sub-account may have their own no-contact list(s). Also, clients or sub-accounts may have their own campaign no-contact list. Some no-contact list records may have a date and time associated with each record to determine when a duration opt out may be observed (e.g., okay to contact client again after 30 days).

At stage 314, the user may establish an Opt-In list or permissions list to define the contact information which may be utilized despite frequency, no-contact lists, or curfew restrictions for such numbers. For example, a consumer may consent to being contacted at their work telephone number after previously indicating they could not be contacted at such number. The consumer may consent to being contacted at a work email address. Other criteria may also be stored, such as modifications to frequency restriction and curfew times.

At stage 316, the user may establish an override list in the database 110. The override list may include the contact information (e.g., telephone number, email address, IP address) for recipients which consent to being contacted. The contact information in the override list may permit an override of frequency, no-contact, or curfew rules. The override may also include additional variables corresponding to effective times and dates in which the override may apply.

At stage 318, the compliance page settings may be stored in a database 110 as compliance rules and variables. The page settings may be stored locally, and may be distributed across a network.

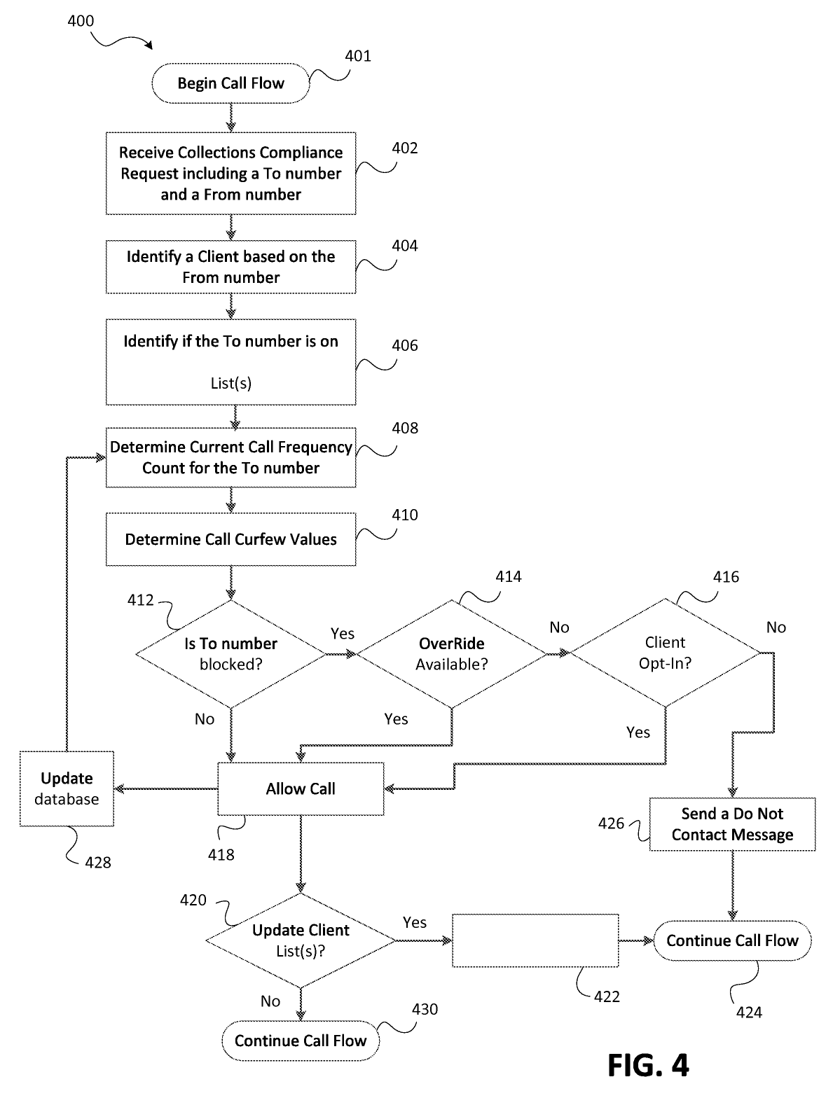

Referring to FIG. 4, with further reference to FIGS. 1-3, a process 400 for processing a potential communication from an origin to a destination includes the stages shown. The process 400 is, however, an example only and not limiting. The process 400 can be altered, e.g., by having stages added, removed, rearranged, combined, and/or performed concurrently. For example, the process 400 provides operational steps that may be processed serially or in parallel and may be performed on different communication channels.

At stage 401, a user or automated call system may begin a call flow. The call flow may be originated via an originating station 104-1 via a PBX. The call flow may originate as part of a CRM system and may include other communication channels such as mail, text, email and fax information.

At stage 402, a control unit 108 may receive a collections compliance request including a To number and a From number. For example, a client agent may initiate a call to IVR 116 of connection unit 114-1 (i.e., a From number) in order to reach a contact user of destination 106-1 (i.e., a To number). After the communications connection between origin 104-1 and connection unit 114-1 is established, control unit 108-1 is configured to determine whether to allow the communications connection with a particular destination 106-1 based on the compliance rules and variables. The To and From numbers may be received via a call-through model such that the client dials a local exchange and then provides the To number. For example, a mobile application may allow a client to call a 1-800- number to access the system and then provide a Personal Identification Number (PIN) and the To number. The To and From numbers may also be forwarded automatically via a PBX when a user dials with an origin 104 device. The From number corresponds to a client (e.g., tbl_clients), and the To number corresponds to a consumer (i.e., destination). The To and From numbers are exemplary only, and not a limitation, as any other information may be used to identify the recipients associated with the To and From numbers (e.g., an email address, IP address, SMS message address, or other computer-readable information). In an example, process 400 may be integrated with a CRM system such that the From and To numbers are provide to the control unit 108 via a web services module (e.g., server), or other data exchange system.

At stage 404, the control unit 108 identifies a client based on the From number. In an example, the database 110 includes a collection of client records (e.g., tbl_Clients) including one or more phone numbers. The database 110 may include a stored procedure program component configured to use the From number as a parameter in a select query for one or more related client tables. Identification of the client enables the control unit 108 to utilize the compliance rules and variables established by the client, for example, as input into a compliance setting page (e.g., process 300). In an example, the Collection Compliance Request is received via a CRM system and control unit 108 may identify the client based on information provided by the CRM system (e.g., IP address, client ID, or other computer-readable data).

At stage 406, the control unit 108 may identify if the To number is one of the client's No-Contact list(s). The control unit may include a stored procedure, or other program element, configured to query a client no-contact list (e.g., tbl_ClientNumberRestrictions) using the To number as a search parameter. If the To number is on a client no-contact list, the call may be blocked at stage 412. The control unit may also determine if To number is included on an Override List (e.g., tbl_EBR_ClientOverRide). The control unit 108 may evaluate the To number in view of account, sub-account and campaign variables to determine if the override requirement is satisfied. Other variables in the tbl_EBR_ClientOverRide table may be used (e.g., add date comparison with no contact list add data). The status of To number on an Override List may be used in a decision to block or allow the call at stage 414.

At stage 408, the control unit 108 may determine the current call frequency count value for the To number. For example, the control unit 108 can query one or more tables containing information relating to completed calls based on the To number (e.g., tbl_CollectionsPhoneRequest, tbl_ClientFrequencySettings). The total number of calls completed in one or more time periods (e.g., day, week) can be compared to the compliance rules and variables associated with calling frequencies (e.g., tbl_RegulatoryFrequencySettings) at stage 412.

At stage 410, the control unit 108 determines the curfew values stored in the database 110. The control unit 108 can query one or more tables containing information relating to curfew periods based on the To number. As an example, and not a limitation, the area code in the To number can be used to query one or more curfew tables (e.g., tbl_RegulatoryCurfews, tbl_CurfewTimes, tbl_ClientCurfew). At stage 412, the control unit 108 can determine the current time of the origin station 104 and the local time of the destination (e.g., based on area code) to determine whether or not the curfew values are not being honored. If the curfew value is being exceed (e.g., the call time is outside of the allowable time periods), then the control unit 108 blocks the attempted call and a message may be provided to the originating station at stage 414.

At stage 412, the control unit 108 determines if the To Number is to be blocked. The logic operation at stage 412 may be based on the no-contact information determined at stage 406, the call frequency count information determined at stage 408, and the call curfew value determined at stage 410. For example, if the total number of calls is greater than then corresponding frequency or frequencies, then the control unit 108 may block the attempted call. If the total number of calls completed in one or more time periods (e.g., day, week) exceeds to the compliance rules and variables associated with calling frequencies (e.g., tbl_RegulatoryFrequencySettings), the attempted call may be blocked. Similarly, the attempted call will be blocked if the curfew times are violated. If the logic operator indicates that the call should continue (i.e., is not blocked), the process 400 allows the call at stage 418. If the logic operation at stage 412 determines that the call is to be blocked, the To number is further evaluated at stage 414.

At stage 414, the control unit 108 determines if the attempted call meets an OverRide requirement. For example, control unit may query one or more database tables (e.g., tbl_EBR_ClientOverRide) to determine is the attempted call qualifies for override handling. The override may be evaluated based on one or more compliance rules and variables and combinations therein. For example, the override status may be established based on client no-contact lists, call frequency count, call curfew values, and the various combinations of these three conditions (e.g., one, two or three are satisfied, one variable may take priority over the other two, two variables may take priority over the third, etc. . . . ). Other compliance rules and variables may be sued to determine if an override is available.

At stage 416, the control unit 108 determines if the attempted call meets an Opt-in Duration requirement. For example the To number may be included on the tbl_ClientExemptionNumbers table along with one or more Exemption Key values. The control unit 108 may evaluate the To number and Exemption Key values in view of account, sub-account and campaign variables to determine if the opt-in requirement is satisfied. Other variables in the tbl_ClientExemptionNumbers table may be used (e.g., Dateadded, Clientsource) to determine if an Opt-in requirement is satisfied.

At stage 426, if the control unit 108 determines that the To number is blocked (stage 412), an OverRide is not available (stage 414), and attempted call does not meet an Opt-In requirement, then the control unit 108 will block the attempted call and may send a do not contact message. For example, a client agent may initiate a call to IVR 116 of connection unit 114-1 in order to reach a contact user of destination 106-1. After the communications connection between origin 104-1 and connection unit 114-1 is established, control unit 108-1 typically determines whether to allow the communications connection with a particular destination 106-1 based on compliance rules and variables in the database 110-1. If, for instance, control unit 108-1 determines that frequency limit is being exceeded, the connection unit 114-1 via IVR 116 may deliver an audio recording to origin 104-1 stating that “The communication cannot be completed because the call frequency limit has been reached.” Other do not contact messages based on the client's no-contact list and the curfew values may also be used as appropriate.

At stage 418, the control unit 108 is configured to allow the call to proceed if the To number is not blocked (stage 412), or an OverRide is available (stage 414), or the attempted call meets a client Opt-In requirement (stage 416). One or more pre-call notification messages may also be provided to the caller before allowing the call at stage 418. A pre-call notification message may be a type of whisper message sent to the caller prior to connection in an effort to provide the caller with information about the consumer. For example, pre-call notification may state the basis for allowing the call (e.g., “the consumer provided opt-in information on [Date]”) The object of the pre-call notification is to provide the caller with information regarding the relevant compliance rules and variables prior to the call.

At stage 428, the control unit 108 may also update the database 110 based on the call parameters. For example, a call list can be appended with a new record to indicate the time and date of a completed call (e.g., tbl_CollectionsPhoneRequest). One or more tables corresponding to an audit log may also be appended or updated (e.g. tbl_AuditLog). The updates may occur in near real time which provides the benefit of collection call compliance across an organization. That is, if multiple agents at a client are working a consumer list, then the activity of a first agent that is captured may cause a second call by a second agent to be prohibited if the second call violates the compliance rules (e.g., the second call could exceed the frequency limits).

At stage 420, the control unit 108 may update one or more client lists. An agent (i.e., caller) may have the option to enter in-call and/or post-call disposition information. The information may be entered by pressing the keys on a telephone, or clicking a link on a CRM user interface, or by providing a voice command. An example could be to update one or more client No-Contact, opt-in or override lists. Multiple lists may be used and updated based on the disposition actions. A post call disposition key may be used to update EBR options, or other fields associated with the compliance rules and variables. At stage 422, is a disposition action is received, the control unit 108 may provide updates such as adding a new number to the database, updating the date stamp associated with the To number such that the date stamp may be used with other compliance rules and variables to determine the activation and/or precedence of the application of rules. The post call disposition key may indicate other action items, such as “follow-up in three weeks,” “follow up with a mailing package,” or other call center/collections related tasks. In-call disposition keys may also be used and the corresponding information updated to the database. For example, an in-call disposition may be used to indicate that the a required legal disclosure was provided to the consumer during a call. Using a debt collection example, the agent may be required to indicate to the consumer that any information they provide may be used for collecting the debt. The in-call disposition action may be activated when the disclosure is made, and a record of receiving the in-call disposition may be saved. Other in-call disposition actions may be used and may vary based on other implementation parameters (e.g., company requirements, state laws).

At stage 424 and stage 430, the process 400 may loop back to the begin call flow element at stage 401. In an example, the process 400 may be used in a batch mode such that a collection of To numbers are provided and the process 400 iterates though each of the numbers in the collection.

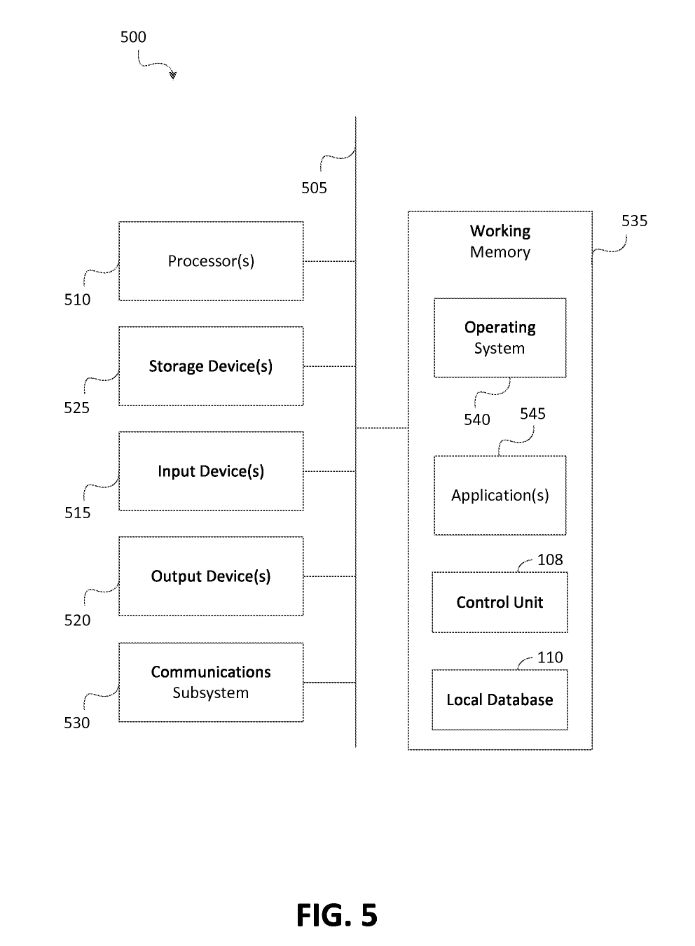

A computer system 500 as illustrated in FIG. 5 may be utilized to at least partially implement the functionality of the previously described computerized devices. FIG. 5 provides a schematic illustration of one embodiment of a computer system 500 that can perform the methods provided by various other embodiments, as described herein, and/or can function as a mobile device or other computer system. FIG. 5 provides a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a mouse, a keyboard and/or the like; and one or more output devices 520, which can include without limitation a display device, a printer and/or the like. The processor(s) 510 can include, for example, intelligent hardware devices, e.g., a central processing unit (CPU) such as those made by Intel® Corporation or AMD®, a microcontroller, an ASIC, etc. Other processor types could also be utilized.

The computer system 500 may further include (and/or be in communication with) one or more non-transitory storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device and/or chipset (such as a BLUETOOTH short-range wireless communication technology transceiver/device, an 802.11 device, a WiFi device, a WiMax device, cellular communication facilities, etc.), and/or the like. The communications subsystem 530 may permit data to be exchanged with a network (such as the network described is control system 100, to name one example), other computer systems, and/or any other devices described herein. In many embodiments, the computer system 500 will further comprise, as here, a working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more processes described herein might be implemented as code and/or instructions executable by a computer (and/or a processor within a computer). For instance, as shown in FIG. 5, one or more of the control unit 108, the local database 110 and/or other functional modules described herein could be implemented via the computer system 500 via processor-executable software code executed from the working memory 535 via the processor(s) 510. Such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as the computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific desires. For example, customized hardware might also be used, and/or particular elements might be implemented in hardware, software (including portable software, such as applets, etc.), or both. Further, connection to other computing devices such as network input/output devices may be employed.

A computer system (such as the computer system 500) may be used to perform methods in accordance with the disclosure. Some or all of the procedures of such methods may be performed by the computer system 500 in response to processor(s) 510 executing one or more sequences of one or more instructions (which might be incorporated into the operating system 540 and/or other code, such as an application programs 545) contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communications subsystem 530 (and/or the media by which the communications subsystem 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, a Blu-Ray disc, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a non-transitory storage devices 525 either before or after execution by the processor(s) 510.

The Collection Compliance System may be implemented on the computer system 500, and may further be integrated with a CRM system (e.g., SalesForce). A CRM system may have components running a server, desktop or mobile devices. The control system 100 may include a web-services configured to communicate with a CRM system. A CRM user may access information (e.g., compliance rules and variables) for a particular consumer using the CRM User Interface (UI). The web-services interface may access the compliance rules and variables contained in the Collection Compliance System and provide the corresponding consumer call information back to the CRM interface. For example, the CRM system can provide a From number and a To number to the web services module and then receive the associated compliance rules and variable information (i.e., call/no contact indications, supporting reasons in the form of whisper messages). In an embodiment, the CRM system may include a “click to call” option to allow a call to be placed through the Collection Compliance System as if the CRM workstation is an origin 104. A “click to call” algorithm may initiate a call back to the user's phone (e.g., office phone, mobile phone, IP address) from the Collection Compliance System, and then the initiation of the call flow as described. The caller may also enter the in-call and post-call disposition information through the CRM UI.

The methods, systems, and devices discussed above are examples. Various alternative configurations may omit, substitute, or add various procedures or components as appropriate. For instance, in alternative methods, stages may be performed in orders different from the discussion above, and various stages may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for selectively prohibiting or allowing a debt collection call, comprising:
receiving a collections compliance request comprising at least a To number and a From number;
identifying a client based on the From number;
determining if the To number is included in a client no-contact list;
determining if a call frequency count value is appropriate, wherein the call frequency count value is based on the To number;
determining if a curfew value is being exceeded based on a current time and the To number;
allowing the debt collection call to proceed if the To number is not included in the client no-contact list, the call frequency count value is appropriate, and the curfew value is not being exceeded; and
prohibiting the debt collection call if the To number is included in the client no-contact list, the call frequency count value is not appropriate, or the curfew value is being exceeded.

2. The method of claim 1 further comprising determining if the To number is included in a sub-account no-contact list, wherein a sub-account is associated with the client.

3. The method of claim 1 further comprising determining if the To number is included in a campaign no-contact list, wherein a campaign is associated with the client.

4. The method of claim 1 wherein the call frequency count value is further based on a sub-account.

5. The method of claim 1 wherein the call frequency count value is further based on a campaign.

6. The method of claim 1 further comprising:
determining if the To number meets an override requirement;
allowing the debt collection call to proceed if the override requirement is met; and
prohibiting the debt collection call if the override requirement is not met, and if any one of the following is true:
the To number is included in the client no-contact list;
the call frequency count value is not appropriate; or
the curfew value is being exceeded.

7. The method of claim 1 further comprising updating a call compliance audit log to indicate whether the debt collection call was allowed or prohibited.

8. The method of claim 1 further comprising sending a pre-call notification message based on the From number.

9. The method of claim 1 wherein the collections compliance request is received by an Interactive Voice Response application.

10. The method of claim 1 wherein the collections compliance request is received from a Customer Relationship Management system (CRM).

11. The method of claim 1 further comprising:
presenting a compliance settings page to a user;
receiving one or more frequency limits;
receiving one or more curfew periods;
receiving one or more client no-contact numbers; and
storing the compliance settings page.

12. The method of claim 1 wherein prohibiting the debt collection call includes prohibiting the debt collection call if the To number is associated with a wireless device.

13. The method of claim 1 wherein prohibiting the debt collection call includes prohibiting the debt collection call if the To number is associated with a particular area code.

14. The method of claim 1 wherein the To number and the From number are computer readable information.

15. A system for assisting an agent in complying with debt collection laws and business requirements, comprising:
a memory;
at least one processor operably coupled to the memory and configured to:
receive a collections compliance request including a To number and a From number;
identify a client based on the From number;
determine if the To number is blocked;
determine is an override is available;
determine if a client opt-in requirement is satisfied;
allowing a call to the To number if the To number is not blocked, or the override is available, or the client opt-in requirement is satisfied; and
blocking the call to the To number is the To number is blocked, and the override is not available, and the client opt-in requirement is not satisfied.

16. The system of claim 15 wherein the at least one processor determines the To number is blocked if the at least one processor determines that a current call frequency count value for the To number is exceeded.

17. The system of claim 15 wherein the at least one processor determines the To number is blocked if the at least one processor determines that a call curfew value is being violated.

18. The system of claim 15 wherein the at least one processor is further configured to provide a pre-call notification message to the agent.

19. The system of claim 15 wherein the at least one processor is further configured to provide a do not contact message to the agent.

20. The system of claim 15 wherein the collections compliance request is received from a Customer Relationship Management system (CRM).
